(19) United States
(12) Patent Application Publication
(10) Pub. No.: US 2005/0099003 A1
(43) Pub. Date: May 12, 2005

(54) Gasket for acid waste couplings

(76) Inventor: James A. Tarara, Westford, MA (US)

Correspondence Address: JOHN E. TOUPAL, 116 CONCORD STREET, FRAMINGHAM, MA, 01701, US

(21) Appl. No.: 09/784,426

(22) Filed: Feb. 16, 2001

(51) Int. Cl. F16L 55/00

(52) U.S. Cl. 285/236; 285/148.23; 285/369

(57) ABSTRACT

A pipe clamp assembly for joining pipe ends of the same or different diameters in a linear relationship for use in acid waste disposal systems. The clamp assembly comprises a flexible clamping band which surrounds the pipe ends to be joined, an elastomeric, circumferential, thin sealing gasket beneath the clamping band and, when joining pipe ends of differing diameters, an elastomeric, circumferential transition coupling within the sealing gasket, the transition coupling having grooves on the exterior surface to engage sealing beads on the interior surface of the sealing gasket, to form a sealing relationship between the exterior surface of the transition coupling and the interior surface of the sealing gasket, and circumferential sealing beads on the interior surface of the transition coupling, to form a sealing relationship with the exterior surface of the reduced diameter joint or pipe to be sealed, thereby providing a clamp assembly adapted to clamp together pipes or joint ends of different diameters. The sealing surfaces of the sealing gasket and transition coupling are layered with teflon to ease assembly, improve sealing, and increase reliability for use in acid waste disposal systems.

### FIELD OF THE INVENTION

The present invention is generally directed toward pipe joint clamping assemblies, and more specifically toward such clamping assemblies intended for use in the joining of variously sized pipes for use in acid waste disposal systems.

### BACKGROUND OF THE INVENTION

Pipe-clamping assemblies are typically employed for the installation and joining of rigid pipes and pipe joints. Such pipe-clamping assemblies clamp together the pipe ends or joint ends in a fluid-tight sealing, aligned relationship. A pipe-clamping assembly may be needed for pipes of various sizes and dimensions. A variety of pipe-clamping assemblies has been proposed, and in particular the pipe-clamping assembly disclosed in U.S. Pat. No. 4,101,151, has provided a simple, easily manufactured, effective clamping assembly which provides for slight variations in external pipe diameters, which patent is hereby incorporated by reference.

The pipe-clamping assembly of the '151 patent comprise a flexible, typically sheet-metal clamping band of a defined length which is adapted to surround circumferentially the ends of the pipe or joints to be joined, and having an underlying, compressible, circumferential sealing gasket adapted to be disposed between the pipe or joint ends and the overlapping clamping bands, so as to overlap and bridge the junctions between the pipe or joint ends. Typically, the sealing gasket is characterized optionally by an outwardly raised central section which fits snugly within a raised central section of the band clamp, to prevent movement of the sealing gasket in the clamping position.

Also, the sealing gasket generally comprises at least a plurality of interior, raised, generally parallel sealing beads on each side of the pipe or joint junctions, so that the sealing beads may engage the exterior surface of the pipe or joints in a sealing relationship, when the clamping assembly is in a clamping position. Further, the sealing gasket comprises an inwardly extending flap or sealing bead generally centrally positioned, against which the abutting edges of the pipe or joints are placed, which further holds the sealing gasket in position and forms a sealing relationship with the abutting ends of the pipe or joints. The clamping assembly also includes a means for tightening the clamping band, so as to compress and place the underlying sealing gasket into a fluid-tight sealing relationship. Typically, the clamping means comprises a pair of flat threadably moveable band straps on either side of the exterior of the clamping band.

A further improvement in the pipe clamp assembly of the above referenced patents is described in U.S. Pat. No. 4,380,348, also hereby incorporated by reference, which patent employs a similar sealing gasket, but which also discloses that the clamping band has an upwardly and reversely extending section along the edge, which section extends toward the underlying pipe or joint, to prevent unwanted outward movement of the sealing gasket in the clamping position.

U.S. Pat. No. 4,480,860 provides a gasket for use where pipe ends or joint ends of different outside diameters are to be joined in a clamping assembly, which commonly arises in the joining of pipes or joints of different outside diameters and of different materials, such as copper, PVC, steel, cast iron and the like, in the plumbing field. The gasket of the '860 patent may be employed using one of the above referenced clamping assemblies in one embodiment, or with other clamping assemblies of the prior art which employ a sealing gasket beneath a circumferential clamp and wherein the sealing gasket contains or is modified to contain an internal structure to permit a sealing relationship between the exterior surface of the pipe transition coupling and the interior surface of the sealing gasket.

It is found that such clamping assemblies as mentioned above are deficient in sealing pipe joints of acid waste disposal systems. Those sealing materials chosen in the above mentioned assemblies for their elastomeric properties provide optimal initial sealing, but are not capable of withstanding the deteriorating effects of the acid waste and are prone to break down and leakage over time under these effects.

Materials such as PTFE, which are capable of withstanding the acidic effects, lack the elastomeric properties needed to provide a satisfactory and reliable seal and cannot conform to slight variations in pipe diameter. PTFE is also very expensive and has various manufacturability limitations for thick-walled applications.

It is therefore desirable to provide an improved pipe-clamping assembly for acid waste disposal systems that contain a removable and replaceable transition coupling that is simple and economical to manufacture and easy to install, and which pipe-clamping assembly avoids the difficulties associated with the deteriorating effects of acid waste.

### SUMMARY OF THE INVENTION

The invention is directed to an improved pipe-clamping assembly containing a pipe transition coupling that has the elastomeric properties of the prior art while additionally providing the acid-resistant properties of PTFE.

The clamping assembly of the invention comprises a flexible clamping band of defined circumference which is adapted to surround circumferentially the ends of the pipes or the joints which are to be joined together and generally to be positioned across and around the abutting pipe or joint ends. The clamping assembly includes a circumferential thin sealing gasket disposed beneath the clamping band. The thin sealing gasket has an interior surface and an exterior surface and a diameter such as to fit over the exterior surfaces of the two pipe ends or pipe joints to be joined where the pipe joints and ends are generally of the same exterior diameter. The thin sealing gasket generally is positioned to overlap centrally the junction between the joint or pipe ends. When the joint or pipe ends are placed in an abutting relationship, the internal surface of the sealing gasket should generally comprise some means to provide exterior seals against the exterior surface of the pipe ends or joints and usually comprises one or two or more pairs of circumferentially spaced-apart generally parallel raised sealing beads thereon. Where the sealing gasket employs two pairs of sealing beads, then usually one pair of each sealing bead is placed on one side and one on the other side of the junction or the abutting ends of the joint or pipe ends to be sealed. The sealing beads are adapted to provide a peripheral sealing relationship against the exterior surface of the pipe or joints to be clamped together by the overriding metal clamping band.

The clamping assembly also includes means to permit the tightening of the metal clamping bands which is generally placed in an overlapping sliding relationship about the sealing gasket, such means to tighten the clamping band often comprises one or two pairs of flat metal clamping bands disposed generally one pair on each side at least of the junction of the joint or pipe ends and adapted to be threadably tightened so that the overlapping tightened clamping band generally retains the underlying sealing gasket in position. If desired, the clamping band may contain a plurality of generally uniformly spaced edge slits therearound to permit a close fitting where pipe diameters tend to vary, such as in clay or soil pipes. In addition, the metal clamping band may contain extending peripheral edges extending downward toward the exterior surface of the pipes to be clamped to prevent further movement of the underlying sealing gasket. The metal clamping band may, if desired, contain a raised central area with the underlying sealing gasket also comprising a raised central area; however, this is not essential and so clamping bands which are generally flat, corrugated or of other nature, may be employed.

Where the joining of two pipes having differing diameters is desired, the clamping assembly of the invention also includes a circumferential pipe transition coupling therein. The transition coupling is employed generally on the side of the clamping assembly having the smaller pipe and is inserted within the sealing gasket; however, if desired, pipe transition couplings of the invention may be employed on each side. The pipe transition coupling is tubular and has an internal diameter surface and an external diameter surface. The external diameter should be substantially the same as the internal diameter of the sealing gasket in the clamp assembly with which the transition coupling is to be employed. The internal diameter of the pipe transition coupling is of less diameter than the internal diameter of the sealing gasket and is selected based on the reduced diameter of the pipe or joint end to be sealed against the internal diameter surface of the pipe transition coupling. The longitudinal length of the pipe transition coupling is less than the longitudinal length of the sealing gasket and generally one half less than the sealing gasket where it fits only on one side of the clamp assembly.

The transition coupling is so structured and formed to have an external diameter surface which permits the external diameter surface of the transition coupling to fit into or about the internal surface of the sealing gasket to form a sealing relationship between the internal surface of the sealing gasket and the external surface of the transition pipe coupling so that the transition coupling when placed on one or the other end of the sealing gasket may be snapped or fitted into place in an easy and generally removable manner. The pipe transition coupling generally has at least one pair of grooves on the external diameter surface which is adapted and so positioned to engage in a snap-in removable sealing relationship with the raised sealing beads on the internal diameter surface of the sealing gasket to form a sealing relationship between the surfaces. Thus, where the sealing gasket comprises one or two pairs of sealing beads on each side of the pipe end or pipe junction, then the corresponding external surface of the transition coupling would have corresponding hemispherical grooves into which the raised sealing beads generally hemispherical in nature would snap-fit or lock so that the transition coupling surface would be easily placed and locked in position. The internal surface of the transition coupling may be smooth, but preferably has some means to form a sealing relationship with the external surface of the reduced diameter pipe end or joint to be sealed and generally comprises at least one pair and sometimes two pairs of generally hemispherical-type or raised sealing beads usually, but not necessarily, of the same type as in the sealing gasket so that on tightening of the metal clamping bands of the clamping band a sealing relationship is easily established against the external surface of the reduced pipe or joint.

Thus, with present prior art sealing gaskets in use, the means to engage the external surface of the transition coupling comprises matching a pair of spaced apart circumferential generally parallel inwardly-directed grooves on the external surface which are adapted to and are engaged matingly in a snap-in sealing relationship with the raised generally parallel beads on the internal diameter surface of the sealing gasket.

The pipe transition coupling is generally composed of a polymeric resilient type material, particularly an elastomeric material generally of the same type of material such as the neoprene, as the sealing gasket in order to avoid any differences in material properties and should be sufficiently resilient so that the material may be forced into position by the plumber or user. The transition coupling then comprises means on the external surface thereof to form a sealing relationship with the internal surface of the sealing gasket or even the metal clamping band, while the internal diameter surface may be smooth or preferably contain means to form a sealing relationship with the exterior relationship of the reduced pipe or joint. The thickness of the transition coupling, of course, depends upon the amount of pipe reduction required with a particular pipe selected. The sealing gasket of the prior art typically employ a centrally disposed annular lip element which extends such as to form a slight elastomeric abutment between the two ends of the pipes or joints to be joined so as to help in the sealing relationship. The sealing gasket may continue to contain such centrally positioned lip and the transition coupling in place generally has one annular edge thereof placed against this lip; however, the use of a lip extending from the transition coupling is not required since, usually with substantial reduction, there is no abutting edge of the opposite pipe or joint end for the lip to fit against.

The critical novelty of the present invention lies in the construction of the thin sealing gasket and the transition couplings. Each comprises an elastomeric core and a lubricious and acid-resistant polymer face. In the preferred embodiment, this lubricious and acid resistant polymer is PTFE, commonly known as teflon, although several other materials, such as polyethylene, polypropylene, delryn, and nylon would serve the purpose with approximate equivalence. On the sealing gasket, this PTFE face covers at least the inner diameter. And on the transition couplings, this PTFE face covers both the inner and outer diameters. The elastomeric core provides the resiliency required to provide a proper seal to pipes of varying dimension and pipes having surface imperfections, while the PTFE faces protect the core from deterioration and maintain the integrity of the seal under the most acidic conditions. The PTFE also possesses slip properties which enhance the joining of slightly oversized pipes by easing the force-fitting of such pipes into the gaskets.

The transition coupling may be made to standard reduction thicknesses and diameters, and, if desired, a transition coupling may be snap-fitted and placed within the interior of another transition coupling where one pipe or joint is to be further reduced or where the particular one transition coupling is not available.

The invention will be described for the purposes of illustration only in connection with a preferred embodiment; however, it is recognized that those persons skilled in the art may make various changes, modifications and additions to the embodiment as illustrated, without departing from the spirit and scope of the invention.

### BRIEF DESCRIPTION OF THE DRAWINGS

FIG. 1 is an exploded, perspective, illustrative view of an improved pipe-clamp assembly of the invention employing a transition coupling,

FIG. 2A is a partial sectional view of a pipe clamp assembly of the invention wherein the sealing gasket comprises an two-shot molding,

FIG. 2B is a partial sectional view of a pipe clamp assembly of the invention wherein the sealing gasket comprises an elastomeric core having a PTFE coating; and

FIG. 3 is a partial sectional view of a pipe clamp assembly of the invention including a transition coupling wherein the gasket and coupling comprise two-shot moldings.

### DESCRIPTION OF THE EMBODIMENTS

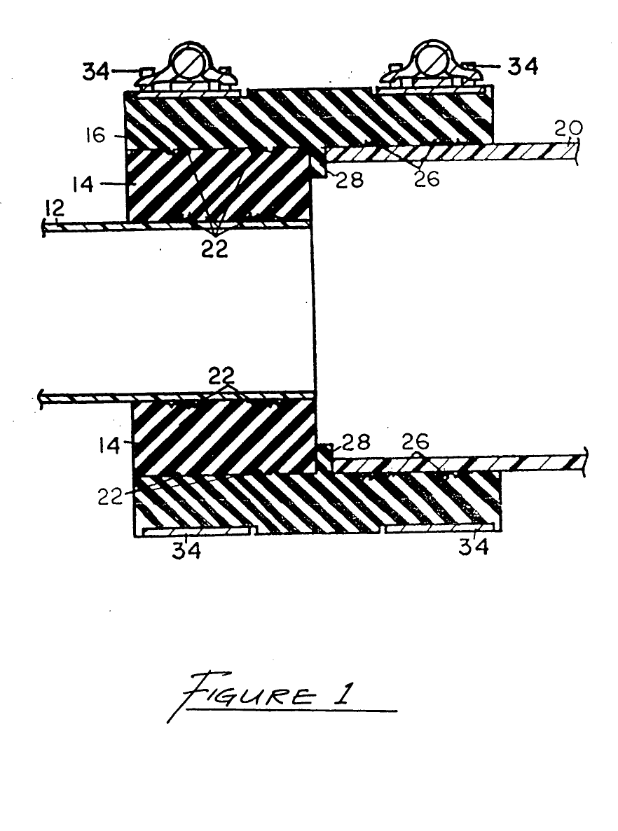

FIG. 1 shows the pipe-clamp assembly of the invention 10 with a pipe 12 of reduced diameter and a pipe 20 of larger diameter each at one end of an improved pipe clamp assembly 10 which comprises a transition pipe coupling 14, a thin sealing gasket 16 and an overlapping metal clamping band 18 having an end 38. The transition pipe coupling 14 contains a pair of sealing gasket ridges 22 on the inner diameter surface thereof and a pair of generally parallel circumferential grooves 24 on the outer diameter surface thereof. The thin sealing gasket 16 has two pairs of sealing gasket ridges 26 extending circumferentially around the internal surface with a pair of ridges extending on each side of an extending centrally disposed lip 28. The sealing gasket 16 includes generally disposed centrally raised ridge 30 about the external surface which fits within the central raised portion 32 of the metal clamping band. The metal clamping band has band straps 34 on either side adapted to be threadably tightened in use and includes a plurality of generally longitudinally uniformly spaced slits 36 on either side of the raised area 32 so that on tightening of the clamping band 18, the band is slideably adjusted to compress the underlying sealing gasket 16 and the transition pipe coupling 14.

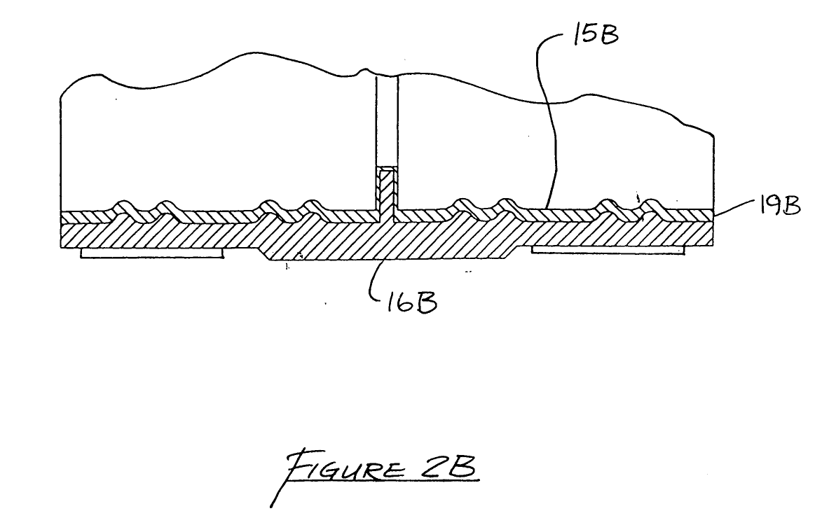

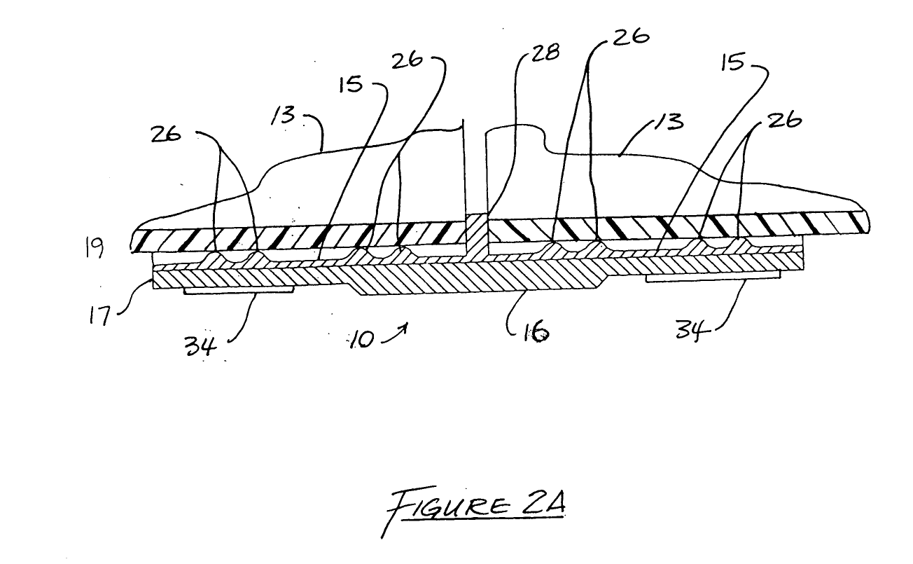

FIG. 2A is a partial sectional view of the improved pipe-clamp assembly of FIG. 1 in use wherein two pipes 13 of the same diameter are held in a tight sealing relationship within the ends of the assembly 10. The threadable flat clamps 34 have been tightened in position such that the pipes 13 are in a sealed, clamped relationship. The sealing beads 26 on the inner surface 15 of the sealing gasket 16 form a sealing relationship as designed with the external surface of the pipes 13 with the end of the pipes abutting against the central lip 28. As illustrated, the sealing gasket 16 is formed of an elastomeric core 17, made of a material such as neoprene, which has been insert-molded around a tubular PTFE inner shell 19. The PTFE internal surface diameter of the sealing gasket 16 is selected to fit the desired diameter of the pipes 13 to be used.

One aspect of the invention that is of particular importance is that central lip 28 is comprised of the acid free polymer. Since this lip is exposed to waste flowing through the pipes, its acid resistance is critical to avoid allowing deterioration to start.

FIG. 2B is a sectional view of an improved pipe clamp assembly similar to that of FIG. 2A, but wherein the sealing gasket 16B is formed by coating the inner surface 15B with a PTFE layer 19B.

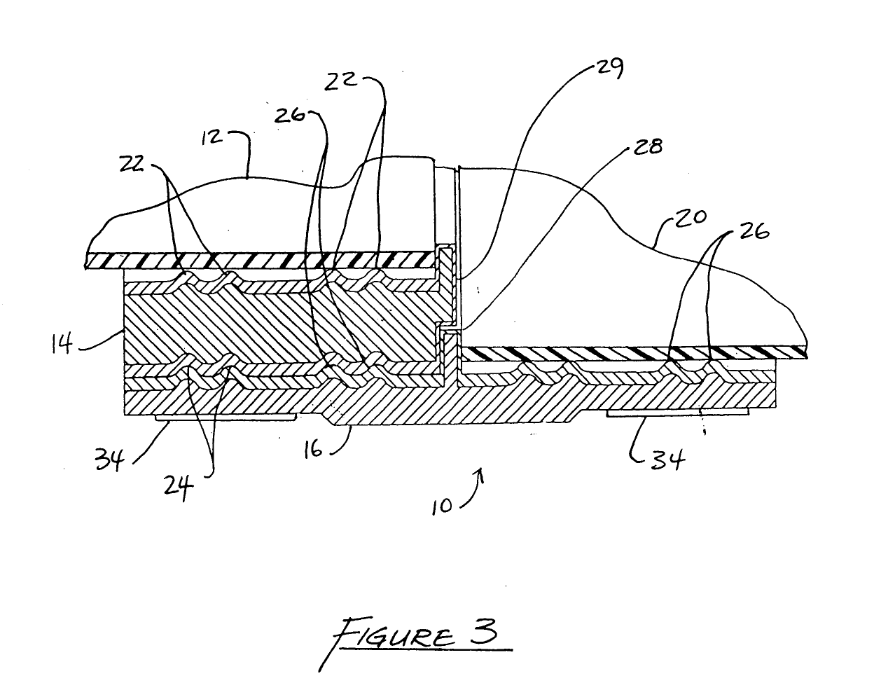

FIG. 3 is a partial sectional view of the pipe-clamp assembly of FIG. 1 in use wherein the small diameter pipe 12 is held in a tight sealing relationship within the one end of the coupling 14 which occupies about one half of the pipe-clamp assembly 10 with one edge of the transition coupling 14 extending against inner central lip 28 and wherein the internal diameter surface of the transition coupling contains raised sealing beads 22 which forms a sealing relationship with the external surface of the reduced pipe 12. The external grooves 24 on the external surface of the transition pipe coupling 14 are shown as snap-fitted onto the raised sealing beads 26 on the internal surface of the sealing gasket 16 so as to form a mating relationship between the internal diameter surface of the sealing gasket 16 and the external surface of the transition coupling 14 wherein the threadable flat clamps 34 have been tightened in position such that the pipes 20 and 12 are in a sealed, clamped relationship. The sealing beads 26 on the opposite side of the sealing gasket 16 form a sealing relationship as designed with the external surface of the large diameter pipe 20 with the end of the pipe abutting against the central lip 28. As illustrated, the transition coupling 14 is formed of an elastomeric core, made of a material such as neoprene, which has been insert molded into a PTFE outer shell 29 and the transition coupling is sufficiently resilient to be force fitted within one half of the sealing gasket 16. The PTFE internal surface diameter of the transition coupling 14 is selected to fit the desired diameter of the reduced pipe 12 to be used, while the PTFE external diameter of the transition pipe coupling 14 is designed to be the same as or just slightly less than the PTFE internal diameter of the sealing gasket 16 with which it is to be used. Where two transition pipe couplings are employed, one on each side, then a sealing gasket of defined diameter may be altered so that one transition gasket can fit on each side so that pipes of different diameter than that from which the sealing gasket was designed may be accommodated on each side.

It should also be appreciated by those skilled in the art that the foregoing presents only the preferred of many possible embodiments of the invention and that the scope of the invention should only be limited by the following claims.

1. In a coupling assembly for linearly joining and sealing the outer diameters of pipe ends, of the type having one or more clamping band which surrounds said pipe ends and an elastomeric circumferential sealing gasket between said one or more clamping band and said outer diameters, and wherein the inner surface of said sealing gasket forms a seal around said outer diameters, the improvement wherein said inner surface comprises a lubricious and acid-resistant polymer.

2. A coupling assembly according to claim 1 wherein said lubricious polymer belongs to the group containing teflon, polypropylene, polyethylene, delryn, and nylon.

3. A coupling assembly of claim 1 wherein said lubricious and acid-resistant polymer comprises teflon.

4. A coupling assembly according to claim 1 wherein said elastomeric sealing gasket is an integrally formed component including an elastomeric base and said lubricious and acid-resistant polymer inner surface.

5. A coupling according to claim 4 wherein said elastomeric base is insert-molded around said lubricious and acid-resistant inner surface.

6. A coupling assembly according to claim 1, further adapted for linearly joining and sealing a first pipe end having a larger outer diameter to a second pipe end having a smaller outer diameter, and including a transition bushing between said sealing gasket and said second pipe end, and wherein the inner surface of said transition bushing forms a seal around said smaller outer diameter and said inner surface of said sealing gasket forms a seal around the outer surface of said transition bushing, the further improvement wherein said inner and outer surfaces of said transition bushing also comprise a lubricious and acid resistant polymer.

7. A coupling assembly according to claim 6 wherein said lubricious polymer belongs to the group containing teflon, polypropylene, polyethylene, delryn, and nylon.

8. A coupling assembly of claim 6 wherein said lubricious and acid-resistant polymer comprises teflon.

9. A coupling assembly according to claim 6 wherein said elastomeric sealing gasket and said transition bushing are each integrally formed components including an elastomeric base and said lubricious and acid-resistant polymer surfaces.

10. A coupling according to claim 9 wherein said elastomeric bases are insert-molded to said lubricious and acid-resistant surface.

11. In a coupling assembly for linearly joining and sealing the outer diameters of pipe ends, of the type having one or more clamping band which surrounds said pipe ends and an elastomeric circumferential sealing gasket between said one or more clamping band and said outer diameters, and wherein the inner surface of said sealing gasket forms a seal around said outer diameters and includes an inwardly protruding circular flange disposed between said pipe ends, the improvement wherein said inner surface and said inwardly protruding flange comprise a lubricious and acid-resistant polymer.

12. A coupling assembly according to claim 11 wherein said lubricious polymer belongs to the group containing teflon, polypropylene, polyethylene, delryn, and nylon.

13. A coupling assembly of claim 11 wherein said lubricious and acid-resistant polymer comprises teflon.
